(19) United States
(12) Patent Application Publication
(10) Pub. No.: US 2026/0230391 A1
(43) Pub. Date: Aug. 6, 2026

(54) ENABLING PROACTIVE ANALYTICS REPORT DELIVERY

(71) Applicant: Telefonaktiebolaget LM Ericsson (publ), Stockholm (SE)

(72) Inventors: Abdulrahman ALABBASI, STOCKHOLM (SE); Konstantinos VANDIKAS, STOCKHOLM (SE); Athanasios KARAPANTELAKIS, ATHENS (GR); Antonio INIESTA GONZALEZ, MADRID (ES); Danesh DAROUI, GÖTEBORG (SE); Attila MITCSENKOV, BUDAPEST (HU)

(21) Appl. No.: 19/149,765

(22) PCT Filed: May 15, 2023
(86) PCT No.: PCT/SE2023/050473

§ 371 Date: Jul. 21, 2025

(30) Foreign Application Priority Data
Jan. 20, 2023 (GR) 20230100043

(51) Int. Cl. H04L 41/142; H04L 41/16

(52) U.S. Cl. CPC H04L 41/142; H04L 41/16

(57) ABSTRACT

According to an aspect, there is provided a computer-implemented method performed by a first network node in a communication network. The method comprises using a Machine Learning, ML model to predict a timing of one or more analytics requests by a second network node to the first network node. An analytics request is a request by the second network node for an analytics report. The method further comprises, before the predicted timing of a first analytics request, obtaining data relating to the first analytics request from one or more data sources; generating a first analytics report relating to the first analytics request by analysing the obtained data; and sending the generated first analytics report to the second network node prior to the predicted timing of the first analytics request.

### TECHNICAL FIELD

This disclosure relates to analytics reports generated by a network node (e.g., a network function) from information obtained by the network node, and in particular to techniques for enabling proactive delivery of the analytics reports by the network node.

### BACKGROUND

In 5^{th} Generation (5G) networks, a service-based architecture is used for the core network, which is broken down into communicating services known as Network Functions (NFs). The 5G system reference architecture comprises a number of different types of NFs/NF instances. One of these NFs is a Network Data Analytics Function (NWDAF) which supports the collection and analysis of data within the network. A “NF Consumer” is a NF that uses or ‘consumes’ a service provided by another NF, which is referred to as a “NF Provider”, “NF Producer” or “NF Source”.

As described in the 3^{rd} Generation Partnership Project (3GPP) Technical Standard (TS) 23.288 (v17.5.0) “Architecture enhancements for 5G System (5GS) to support network data analytics services”, the data collection coordination and delivery process is applied to:
NWDAFs that request data from a data source (e.g., for use in computing analytics).
NF consumers that request analytics from an instance of NWDAF.
NF consumers that request data from an instance of an Analytical Data Repository Function (ADRF).
ADRFs that receive data from NFs as data sources.

This disclosure relates to a problem with a NF consumer requesting analytics from a NWDAF, and a NWDAF collecting data from a source NF (or other entity that can be a source of data) to be processed and delivering it to the consumer NF. The above process collection and delivery procedure applies to the techniques described herein.

The data collection process is supported by a Data Collection Coordination Function (DCCF) (including source and consumer NFs, noting that a NWDAF could be a source or consumer NF) and can be summarized (according to 3GPP TS 23.288) as:
Once NF-A consumer requests data from DCCF:
   If the requested data is locally available (if requested by other NFs)
      Forward the requested data to the new NF-A
   If not, retrieve the requested data from the data source.

### SUMMARY

Prefetching is a well-researched topic, particularly when it comes to accessing content between a central processing unit (CPU) and its memory (primary/secondary), but also in computer networks where proxy servers are used to collect and make available not only the content/data that one user has asked for and that others may also ask for, but also the content that a user may ask for next.

From the NWDAF's perspective, the NWDAF could collect data for use in producing analytics from all available data, including:
Operations, Administration and Maintenance (OAM) global NF data;
Data available in NFs, e.g., behaviour data related to individual User Equipments (UEs) or UE groups (e.g., UE reachability), and pre-computed metrics covering UE populations (e.g. a number of UEs present in a geographical area), per spatial and temporal dimensions (e.g. per region for a period of time),
NF data available in the 5G Core (5GC) (e.g., a Network Repository Function (NRF) which provides a NF discovery and selection service for other NFs),
Data available in an Application Function (AF).

There are a couple of considerations for motivating the prefetching of data to enable proactive analytics delivery according to the techniques described herein. These considerations are based on 3GPP TS 23.288:
When a request or subscription for statistics or predictions is received, the NWDAF may not possess the necessary data to perform the service, including:
   Data on the monitoring period in the past, which is necessary for the provision of statistics and predictions matching the analytics target period.
   Data on longer monitoring periods in the past, which is necessary for model inference.
The NWDAF preparation for data collection from a NF is a considerable procedure, which is illustrated in FIG. 1 and described below.

FIG. 1 shows the signalling between a NWDAF 10, a Unified Data Management (UDM) node 12 and a NF 14 to enable the NWDAF 10 to collect the information/data required to generate an analytics report using an inference model. At step 101 the NWDAF 10 sends a Subscriber Data Management (SDM) Get request to the UDM 12 (e.g. Nudm_SDM_Get) and receives a corresponding reply. The Get request is used to check whether data can be collected for a user depending on local policy and regulations. The Nudm_SDM_Get is issued with a “User Consent” datatype. If user consent is granted, then it is possible to subscribe to UDM for notifications of changes in subscription.

At step 102 the NWDAF 10 sends a SDM Subscribe request to the UDM 12 (e.g., Nudm_SDM_Subscribe) and receives a corresponding reply confirming that the subscription has been established. The Subscribe request is used to subscribe to notifications of changes of subscription data type “User Consent” for this user.

At step 103 the NWDAF 10 subscribes to an event at the NF 14 by sending an event exposure subscribe request to the NF 14 (e.g. Nnf_EventExposure_Subscribe) and receives a corresponding reply confirming that the subscription has been established. When the NWDAF 10 no longer wishes to subscribe to the event at the NF 14, the NWDAF 10 can send an unsubscribe request for that event to the NF 14 (e.g. Nnf_EventExposure_Unsubscribe).

At step 104, when the event occurs at the NF 14, the NF 14 notifies the NWDAF 10 of the occurrence of the event. This can be sent in an event exposure notify message (e.g. Nnf_EventExposure_Notify).

At step 105, the UDM 12 notifies the NWDAF 10 of whether the user has agreed to share data using a SDM notify message (e.g. Nudm_SDM_Notify).

At step 106, when the NWDAF 10 no longer wishes to subscribe to the event at the NF 14, and the NWDAF 10 sends an unsubscribe request for that event to the NF 14 (e.g. Nnf_EventExposure_Unsubscribe). The NWDAF 10 receives a corresponding reply confirming that the subscription has been unsubscribed.

At step 107, when the NWDAF 10 no longer wishes to subscribe to the SDM at the UDM 12, and the NWDAF 10 sends an unsubscribe request to the UDM 12 (e.g., Nudm_SDM_Unsubscribe). The NWDAF 10 receives a corresponding reply confirming that the subscription has been unsubscribed.

The problem in short, given the above discussion, is if a NF consumer requests new analytics, how can the NWDAF be prepared for delivery of those analytics. For the NWDAF to ‘be prepared’ it should 1) aim to reduce the time required for analytics preparation, and 2) ensure that the NWDAF possesses enough data for this specific NF consumer once it is requested.

In other words, if a NF consumer requests new analytics from a NWDAF, but the NWDAF has not yet collected enough data to provide these analytics and has to start a process for data collection, the analytics may be provided to the NF consumer after a considerable time.

Certain aspects of the disclosure and their embodiments may provide solutions to these or other challenges.

In this disclosure, the response of the NWDAF (i.e., the data analytics report) or the next response is not particularly of interest, but instead it is desirable to know or learn the access pattern between a NF and NWDAF. In this way the NWDAF can be prepared ahead of time, so that it can provide up-to-date predictions or provide sufficient analytics for the requested time frame.

This disclosure provides techniques, for example implemented in the form of a logical function, that enables a NWDAF to predict the analytics request pattern of a NF consumer, which allows the NWDAF to request the relevant data from data sources ahead of time, so that the NWDAF is prepared to deliver completely fresh (i.e. up to date) analytics reports. Further, embodiments of the disclosure techniques provide that the NWDAF can send the analytics report to the relevant NF consumer prior to the request for the analytics being sent by the nf consumer.

In embodiments of this disclosure, a logical function, which can be part of the NWDAF, referred to as a Prefetching Pattern Model Provider (PPMP), trains ML models that enable the prediction of a analytics request pattern for a NF consumer. The NWDAF can then use that prediction to pre-fetch the data from one or more data sources (e.g., different NF data sources) ahead of time (i.e. ahead of when the analytics request is to be sent), while keeping the predicted analysis fresh (up to date) enough for inference purposes. Hence, the NWDAF can proactively provide the up to date analytics report to the NF consumer. Alongside the proposal for an artificial intelligence (Al) agent to perform the functionality of the PPMP, this disclosure also proposes a signalling procedure to enable this mechanism.

According to a first aspect, there is provided a computer-implemented method performed by a first network node in a communication network. The method comprises using a machine learning, ML, model to predict a timing of one or more analytics requests by a second network node to the first network node. An analytics request is a request by the second network node for an analytics report. The method further comprises, before the predicted timing of a first analytics request, obtaining data relating to the first analytics request from one or more data sources; generating a first analytics report relating to the first analytics request by analysing the obtained data; and sending the generated first analytics report to the second network node prior to the predicted timing of the first analytics request.

According to a second aspect, there is provided a computer-implemented method performed by a first network node in a communication network. The method comprises obtaining information on a timing of previous analytics requests by one or more other network nodes and training a ML model using the obtained information. The previous analytics requests are requests to the first network node for one or more analytics reports, and the ML model is trained to predict a timing of a first analytics request for a first analytics report.

According to a third aspect, there is provided a computer program product comprising a computer readable medium having computer readable code embodied therein, the computer readable code being configured such that, on execution by a suitable computer or processor, the computer or processor is caused to perform the method of the first aspect, the second aspect, or any embodiment thereof.

According to a fourth aspect, there is provided a first network node for use in a communication network. The first network node is configured to use a ML model to predict a timing of one or more analytics requests by a second network node to the first network node. An analytics request is a request by the second network node for an analytics report. The first network node is further configured to, before the predicted timing of a first analytics request, obtain data relating to the first analytics request from one or more data sources; generate a first analytics report relating to the first analytics request by analysing the obtained data; and send the generated first analytics report to the second network node prior to the predicted timing of the first analytics request.

According to a fifth aspect, there is provided a first network node for use in a communication network. The first network node is configured to obtain information on a timing of previous analytics requests by one or more other network nodes and train a ML model using the obtained information. The previous analytics requests are requests to the first network node for one or more analytics reports, and the ML model is trained to predict a timing of a first analytics request for a first analytics report.

According to a sixth aspect, there is provided a first network node for use in a communication network. The first network node comprises a processor and a memory, said memory containing instructions executable by said processor whereby said first network node is operative to use a ML model to predict a timing of one or more analytics requests by a second network node to the first network node. An analytics request is a request by the second network node for an analytics report. The first network node is further operative to, before the predicted timing of a first analytics request, obtain data relating to the first analytics request from one or more data sources; generate a first analytics report relating to the first analytics request by analysing the obtained data; and send the generated first analytics report to the second network node prior to the predicted timing of the first analytics request.

According to a seventh aspect, there is provided a first network node for use in a communication network. The first network node comprises a processor and a memory, said memory containing instructions executable by said processor whereby said first network node is operative to obtain information on a timing of previous analytics requests by one or more other network nodes and train a ML model using the obtained information. The previous analytics requests are requests to the first network node for one or more analytics reports, and the ML model is trained to predict a timing of a first analytics request for a first analytics report.

Certain embodiments may provide one or more of the following technical advantage(s). For example, the techniques described herein can avoid problematic cases where congestion in the network prevents the NWDAF from collecting the data for the inference (i.e. the data required for preparing the report) and/or prevents the NWDAF from providing the analytics report to the NF consumer. In another example, the techniques described herein can avoid cases where the time available to collect the data (i.e. the time until the analytics report is to be delivered) is insufficient. As another example, the techniques described herein can keep the proactive delivery of analytics reports up to date and relevant to the NF consumer requesting the report. In another example, the techniques described herein can reduce or avoid the inefficient collection of data and/or delivery of analytics reports.

### BRIEF DESCRIPTION OF THE DRAWINGS

Some of the embodiments contemplated herein will now be described more fully with reference to the accompanying drawings, in which:

FIG. 1 shows the signalling between a NWDAF, a UDM and a NF to enable the NWDAF to collect information/data required to generate an analytics report using an inference model;

FIG. 2 is a signalling diagram illustrating a prefetching procedure for a NWDAF according to various embodiments;

FIG. 3 is a block diagram illustrating a logical function for collecting pattern data for analytics reports and training a ML model;

FIG. 4 is a block diagram illustrating a NWDAF (Analytics Logical Function (AnLF)-based solution for collecting pattern data for analytics reports and training a ML model;

FIG. 5 is a block diagram illustrating a NWDAF (Model Training Logical Function (MTLF))-based solution for collecting pattern data for analytics reports and training a ML model;

FIG. 6 is a flow chart illustrating a method of operating a network node according to some embodiments;

FIG. 7 is a flow chart illustrating another method of operating a network node according to some embodiments;

FIG. 8 is a block diagram of a network node in accordance with some embodiments; and

FIG. 9 is a block diagram illustrating a virtualization environment in which functions implemented by some embodiments may be virtualized.

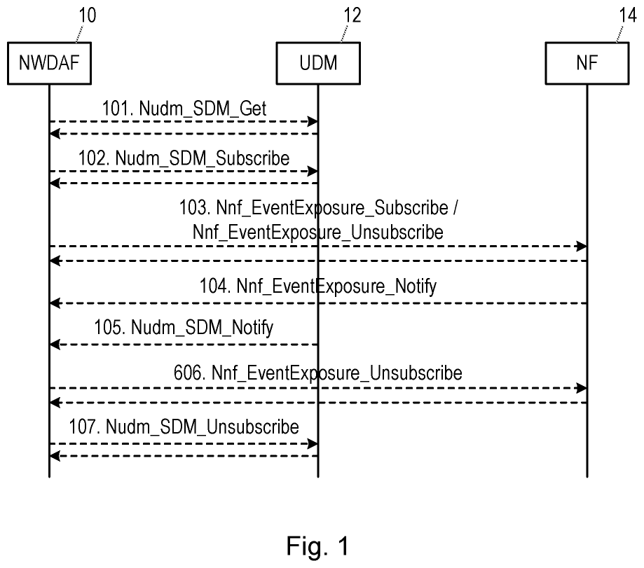

### DETAILED DESCRIPTION

As noted above, this disclosure addresses the problem where an NWDAF is not prepared for the delivery of analytics when a NF consumer requests new analytics. This can lead to a delay from when the analytics were requested to their delivery. The techniques described herein provide that the NWDAF, or other network data analytics node, can predict the analytics request pattern of a NF consumer, which allows the NWDAF to request the relevant data from data sources ahead of time, so that the NWDAF is prepared to deliver completely fresh (i.e. up to date) analytics reports. In some embodiments, the NWDAF or other network data analytics node can send the analytics report to the relevant NF consumer prior to the request for the analytics being sent by the NF consumer. The terms “analytics request” and “data analytics request” are used interchangeably herein, as are the terms “analytics report” and “data analytics report”.

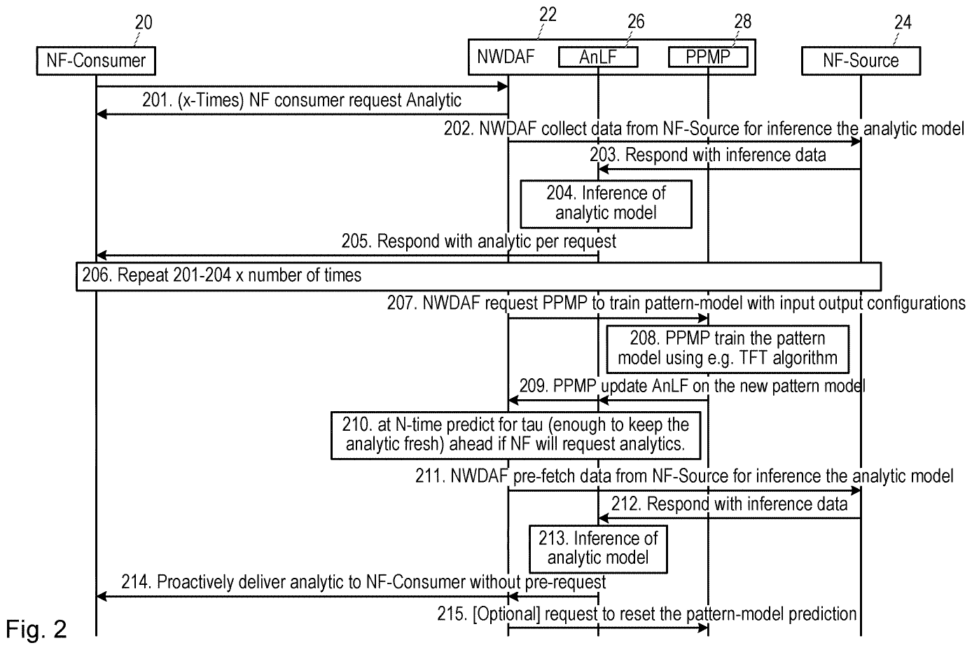

The signalling diagram in FIG. 2 shows the signalling between a network node 20 (e.g. NF consumer 20), another network node 22 in the form of an NWDAF or other network data analytics node, and a NF Source 24. In the illustrated embodiment the NWDAF 22 comprises an Analytics Logical Function (AnLF) 26 which is a part of a NWDAF 22 that is responsible for generating reports or analytics (‘data analytics reports’) using a machine learning (ML) model (also referred to herein as an “analytics model” or an “inference model”). The NWDAF 22 is also shown as including the PPMP 28. Although not shown in FIG. 2, the NWDAF 22 can also include a Model Training Logical Function (MTLF) that is responsible for providing and/or training the ML models for use by the AnLF 26.

According to the techniques described herein, prefetching procedures are introduced for the NWDAF 22 so that it is prepared for analytics delivery to the NF consumer 20 based on a prefetching pattern model (PPM) that is provided by the PPMP 28, while keeping the analytics information that is to be shared as fresh/new/up-to-date as possible.

The NWDAF preparation process of FIG. 2 comprises the following signals and steps:

In step 201, the NF consumer 20 subscribes to analytics from the NWDAF 22 (and receives acknowledgements of those subscription requests from the NWDAF 22). That is, the NF consumer 20 sends one or more analytics requests to the NWDAF 22 that respectively request the NWDAF 22 to send an analytics report.

Optionally, if an analytic model for providing the analytics reports is not already trained, or requires retraining, the NWDAF 22 (e.g. the MTLF) can obtain suitable training data and train or retrain the analytic model. This training data may be obtained from the one or more NF sources 24.

At step 202, the NWDAF 22 requests the data required for generating the analytics reports from one or more NF Sources 24 (i.e., data sources-sources of the data). At step 203 the NF source 24 sends the required data to the AnLF 26. This data is referred to as “inference data”, as it is data that is to be used by the inference model to generate an inference (the analytics report).

At step 204 the AnLF 26 uses the trained ML model and the collected data to generate the analytics report for the NF consumer 20. At step 205, the NWDAF 22 (e.g. AnLF 26) sends the analytics report to the NF consumer 20.

According to step 206, steps 201-205 can be repeated many (e.g. x) times before the process moves on to the subsequent steps. In the subsequent steps the prefetching pattern model is trained, so steps 201-205 (and in particular step 201) need to be repeated enough times for create a suitable set of training data for the PPMP 28 to use to generate the PPM. The value of x may be predetermined.

In step 207, the NWDAF 22 requests the PPMP 28 to train the PPM with input output configurations. That is, the PPM can be trained using supervised learning with combinations of <input, output>, where the input is a collection of data points corresponding to features, and output is also a collection of data points, known as the “labels” or “ground truth”. At step 208, the PPMP 28 trains the PPM so that the PPM is able to provide a prediction of the timing of analytics requests by the NF consumer 20. Further details of the training of the PPM, the inputs and outputs of the PPM, are provided below.

In step 209 the PPMP 28 provides the trained PPM to the AnLF 26 and/or the MTLF.

In step 210, according to a particular period N, the NWDAF 22 or AnLF 26 in the NWDAF 22, the NWDAF 22/AnLF 26 uses the trained PPM to predict the timing of a next analytics request from the NF consumer 20. The timing prediction can be expressed as a time τ (Tau) before a analytics request is predicted to occur, and which takes into account a time required for the NWDAF 22 to collect the data for generating the analytics report. The value of N has to be short enough to avoid any request event from being missed, and the value of τ (Tau) should be large enough to allow for the following steps 211-214 for analytics preparation.

In step 211, the NWDAF 22/AnLF 26 starts to collect (pre-fetch) the data required to do the inference from one or more NF data sources 24. Step 212 shows the provision of the inference data from the one or more NF sources 24 to the AnLF 26.

At step 213, the AnLF 26 uses the analytic model to generate the analytics report for the NF consumer 20. In step 214, the AnLF 26/NWDAF 22 sends the analytics report to the NF consumer 20. Preferably, step 214 occurs before the NF consumer 20 has actually made the request for the analytics report, and thus the NWDAF 22 has proactively provided the analytics report to the NF consumer 20.

Step 215 is an optional step in which the NWDAF 22 requests the PPMP 28 to reset (i.e. the prediction is reset, so the PPMP 28 is used to predict the next time period N).

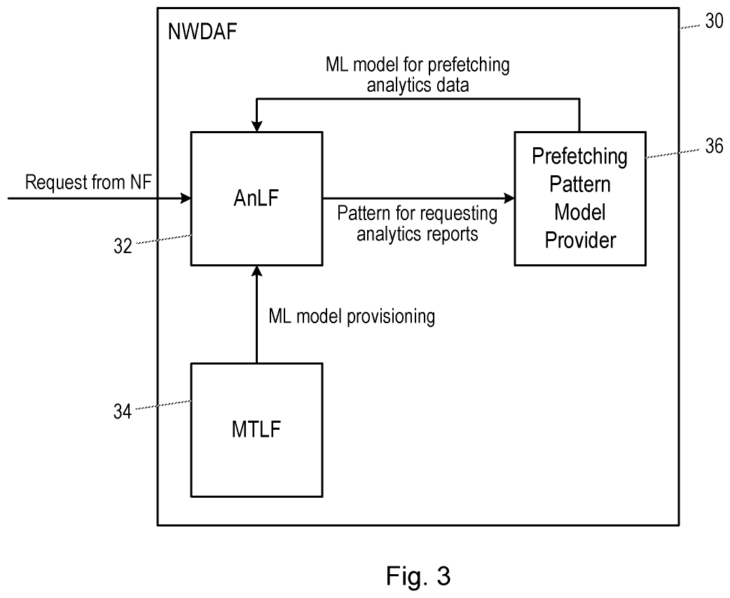

FIGS. 3-5 illustrate different ways to implement a PPMP in a NWDAF.

FIG. 3 is a block diagram illustrating a logical function (PPMP) in the NWDAF for collecting pattern data for analytics reports and training a prefetching pattern model (PPM). The NWDAF 30 in FIG. 3 comprises an AnLF 32, a MTLF 34 and a PPMP 36. The AnLF 32 receives the analytics report subscription from a NF consumer and requests the PPMP 36 to provide a model for predicting the pattern of analytics requests. The PPMP 36 will get relevant training data from the AnLF 32, for example including an analytics identifier (ID), timestamp, and analytics filter information, and then train a ML model to predict the timing of requests for analytics reports from a service consumer. In this implementation, the PPMP 36 provides the trained prediction model to the AnLF 32, and the AnLF 32 runs the model to determine the timing of future analytics requests. The MTLF 34 determines (trains) the prediction model used by the AnLF 32 to generate the analytics report, and provides this prediction model to the AnLF 32 for use when the AnLF 32 is to generate the analytics report.

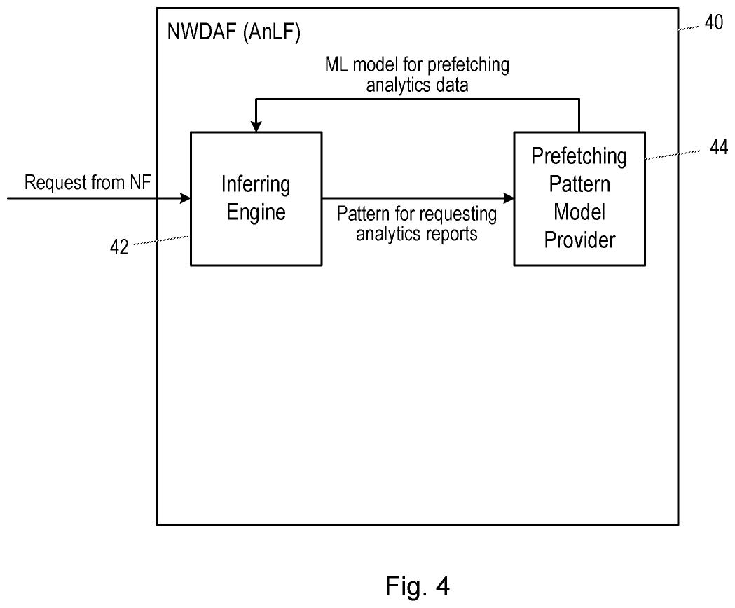

FIG. 4 is a block diagram illustrating an alternative implementation in which the PPMP is part of (e.g. embedded inside) the AnLF of a NWDAF, and the PPMP receives all the necessary training data via the AnLF. Here, the NWDAF/AnLF 40 comprises an inferring engine 42 (which is responsible for using ML models to generate an output) and a PPMP 44. The AnLF 40 receives the analytics report subscription from a NF consumer and requests the PPMP 44—via the inferring engine 42—to provide a ML model for predicting the pattern of analytics requests. The inferring engine 42 can execute the PPM to predict the timing of future analytics requests, and execute the ML model to generate the analytics report(s) using pre-fetched data.

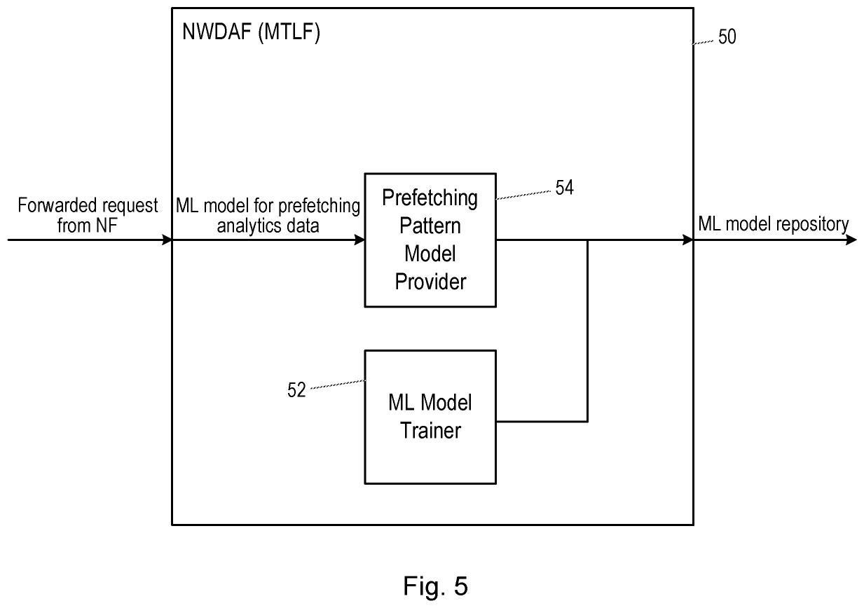

FIG. 5 is a block diagram illustrating another alternative implementation in which the PPMP is part of (e.g. embedded inside) the MTLF of a NWDAF. The NWDAF/MTLF 50 comprises a ML Model Trainer 52 that is responsible for training ML models using training data, and the PPMP 54. The training data used by the PPMP 54 is read from an AnLF, and the PPMP 54 trains a PPM. When this ML PPM is trained, it can be stored in a model repository that is used by the MTLF 50 for storing other ML models, including those used to generate the data analytics reports. The MTLF 50 is configured to provision the PPM to the AnLF when requested.

The following section provides details of the training of the PPM, and the inputs and outputs of the PPM, in particular for an example where the analytics request/report relates to user data congestion in the communication network, which can be consumed/used by NFs such as a Network Exposure Function (NEF), an AF and/or a Policy Control Function (PCF).

The NWDAF/AnLF requests the PPMP to train the prefetching pattern model (PPM), and provides the PPMP with input and output information related to PPM supervised training. The input information can include any one or more of: analytics-related information (e.g., congestion-specific analytics), NF-related information and data source-related information.

The analytics-related information can comprise information such as any one or more of: ID, timescale, target periodicity, target UE, analytic filter information, Area of Interest (AoI), Single-Network Slice Selection Assistance Information (S-NSSAI), related performance measurements (e.g. from an OAM), UE location (from an Access and Mobility Function (AMF)), throughput uplink (UL)/downlink (DL), sampling ratio, App ID, Internet Protocol (IP) filter (from a User Plane Function (UPF)/AF).

The NF-related information can comprise information such as any one or more of: the requesting NF, a domain or tracking area, a type and/or an instance, number of users controlled by that NF, a congestion between the NF consumer and the NWDAF.

The data source-related information can comprise information such as any one or more of: the response time from the data source, the number of times the source has dropped, etc.

Some the above types of input information can be considered to be metadata.

The output of the trained PPM comprises information on the timing of future analytics requests. This timing information can be in the form of timeslots and periodicity (temporal information) of future requests from a NF consumer for specific analytics (e.g., congestion analytics as described in 3GPP TS 23.288), and/or specific parameters. The parameters can include any of a target service, aggregation, area of interest, or user of interest. In some embodiments, the above timeslot and periodicity of an analytics request could be considered for a specific analytics parameter such as congestion-specific analytics. The temporal information above can be provided and associated with selected parameters in Table 6.8.3-1/2 of 3GPP TS 23.288, such as congestion level, confidence, percentage of throughput, and Application ID. The above output information could be obtained via classification or regression agents, depending on granularity.

The PPM may be any suitable type of ML model. The PPM is a time-series forecasting model, which can use one of the following techniques: autoregressive moving average (ARMA), or autoregressive integrated moving average (ARIMA), a long short-term memory, LSTM, forecasting model; a recurrent neural network, RNN; an attention-based LSTM forecasting model and transformers; a N-BEATS model (e.g. ElementAI); a DeepAR model, a Temporal Fusion Transformer, TFT, model (e.g., as described in “Temporal Fusion Transformers for Interpretable Multi-horizon Time Series Forecasting” by Bryan Lim et. al, https://arxiv.org/pdf/1912.09363.pdf); or a Spacetimeformer model (e.g., as described in “Long-Range Transformers for Dynamic Spatiotemporal Forecasting” by Jake Grigsby et. al, https://arxiv.org/pdf/2109.12218.pdf).

In a TFT architecture for the PPM, the TFT inputs static metadata, time-varying past inputs, and time varying a priori known future inputs. Variable Selection is used for judicious selection of the most salient features based on the input. Gated Residual Network blocks enable efficient information flow with skip connections and gating layers. Time-dependent processing is based on LSTMs for local processing, and multi-head attention for integrating information from any time step.

In an extension to the above embodiments, the data can be prefetched for the purposes of training or retraining the PPM. For example, there can be a communication signal between the AnLF and the MTLF that triggers the MTLF or PPMP to (re)train the PPM. Thus, the PPMP can collect/receive a request for retraining from the AnLF, and the PPMP can collect/receive a detected drift occasion from the MTLF. That is, the MTLF can detect a model drift, meaning that the performance/accuracy of the ML model has degraded, suggesting that retraining of the ML model is required. Thus, if model drift is detected, the data for (re-)training can be prefetched.

The retraining by the PPMP may result in a completely new PPM, or a refined version of the previous PPM. A refined version may be obtained by changing the input and/or output training data to counter the model drift that has been detected (e.g. the input/output dataset can be changed, or the prediction model can be reengineered by changing the input features and/or the output classes).

In a different or further extension of the above embodiments, the PPMP can be ‘personalised’ to a specific NF consumer. In particular, depending on the scarcity of a particular request pattern, which can happen if the input information becomes very narrow, for example for a specific analytical ID, timescale, periodicity, target service, aggregation, AOI, set of users, type of requests, specific NF, etc., instead of maintaining a single PPMP function for all NF consumers, a personalised PPMP (pPPMP) can be created which is tasked to handle such requests between a NWDAF-NF consumer pair for the purpose of improving the accuracy of the pPPMP. Here, accuracy refers to the prefetching pattern as opposed to the accuracy of the actual prediction of the given NWDAF monitored by the PPMP.

The decision to generate such a function can be made between a NF Consumer and the NWDAF when the NF consumer notices a ‘miss’ or in other words an NWDAF whose request timing predictions may not be valid since the NWDAF was not trained as recently as expected by the NF consumer. In that case the NF consumer can send a new request to the general PPMP (gPPMP) to generate a pPPMP, which is a module trained exclusively with the request pattern data of that NF consumer to the NWDAF to match the timing predictions from the PPM to the individual NF consumer's request pattern style. If or when the NF consumer validates the pattern produced by the pPPMP, the pattern can then be used to determine the model training/retraining cycle of the NWDAF.

In a further extension, personalisation could be built via multiple per NF private models, and having personalised data for training that private model, or via conditioning on the overall model with personalised parameter(s) of the specific NF consumer.

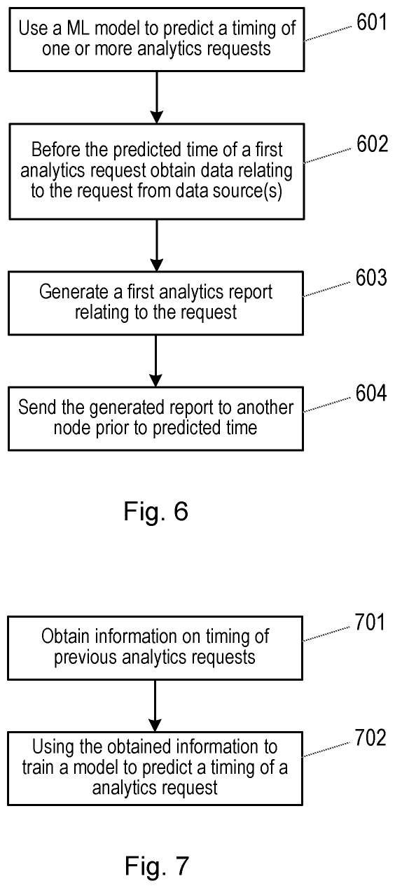

FIG. 6 is a flow chart illustrating a computer-implemented method according to various embodiments performed by a first network node in a communication network. In some embodiments, the first network node is a NF, a network data analytics node or function (i.e., a node or function that determines or provides data analytics about a network), such as a NWDAF. In alternative embodiments, the first network node can be one or more logical functions in a NWDAF. The first network node may perform the method in response to executing suitably formulated computer readable code. The computer readable code may be embodied or stored on a computer readable medium, such as a memory chip, optical disc, or other storage medium. The computer readable medium may be part of a computer program product.

In step 601, the first network node uses a ML model to predict a timing of one or more analytics requests. These analytics requests are from a second network node to the first network node, and an analytics request is a request by the second network node for an analytics report. In some embodiments, step 601 is performed by an AnLF.

In step 602, which is before the predicted timing of a first analytics request, the first network node obtains data relating to the first analytics request from one or more data sources. That is, prior to the first analytics request being received, the first network node pre-fetches the data required for the analytics.

In step 603, the first network node generates a first analytics report relating to the first analytics request by analysing the obtained data. Step 603 can comprise using a report generation model to generate the first analytics report.

In step 604, the first network node sends the generated first analytics report to the second network node prior to the predicted timing of the first analytics request. If the predicted timing is sufficiently accurate, the first analytics report will be sent to the second network node prior to an analytics request for that analytics report being received from the second network node.

Thus, the method provides that, after predicting the timing of an analytics request, the first network node has both obtained (prefetched) the data needed to perform the analytics, and prepared and sent the analytics report to the requester, before the analytics request is actually sent by the second network node.

The ML model used in step 601 may further predict one or more of the following parameters or characteristics associated with the first analytics request. In particular, the ML model can predict a subject of the first analytics request, e.g., the type of analytics report that is required. The ML model can predict an identity of the second network node, i.e., the ML model predicts which network node is going to send the analytics request. The ML model can predict an identity of one or more other network nodes to which the first analytics report is to be sent, i.e., the ML model can predict which other network nodes might make a similar analytics request and/or which other network nodes might benefit from receiving the same analytics report. The ML model can predict a type of network node to which the first analytics report is to be sent, e.g., SMF, PCF, etc. The ML model can predict a type of data required to generate the first analytics report, e.g., network congestion data, etc. The ML model can predict a minimum time period required to obtain the data that is needed for generating the first analytics report, e.g., so that the first network node can allow enough time to prefetch the data before an analytics request is received. The ML model can predict a periodicity for the first analytics request, i.e., predict how often the analytics request will be made.

FIG. 7 is a flow chart illustrating another computer-implemented method performed by a first network node in a communication network according to various embodiments. In some embodiments, the first network node is a NF, a network data analytics node or function (i.e., a node that determines or provides data analytics about a network), such as a NWDAF. In alternative embodiments, the first network node can be one or more logical functions in a NWDAF. The network node may perform the method in response to executing suitably formulated computer readable code. The computer readable code may be embodied or stored on a computer readable medium, such as a memory chip, optical disc, or other storage medium. The computer readable medium may be part of a computer program product. The network node that performs the method in FIG. 7 may also perform the method described above with reference to FIG. 6, but in other implementations different network nodes can perform the methods in FIGS. 6 and 7.

In step 701, the first network node obtains information on a timing of previous analytics requests by one or more other network nodes (e.g., other NFs). The previous analytics requests are requests to the first network node for one or more analytics reports. This obtained information is used as training data for training a ML model in step 702.

Thus, in step 702, a ML model is trained using the obtained information. In particular, the ML model is trained to predict a timing of a first (i.e., future) analytics request for a first analytics report by the one or more other network nodes. Step 702 can be performed by a MTLF. Alternatively, the ML model can be trained in an AnLF. The trained ML model may be stored in a ML model repository. In some embodiments, the method further comprises providing the trained ML model to an AnLF.

The ML model trained in step 702 may be any of a: time-series forecasting model; an ARMA forecasting model; an ARIMA forecasting model; a LSTM forecasting model; a RNN; an attention-based LSTM forecasting model; a N-BEATS model; a DeepAR model, a TFT model; and a Spacetimeformer model. The ML model trained in step 702 can then be used in step 601 (e.g. by an NWDAF or AnLF) to predict a timing of one or more future analytics requests.

The training of the ML model in step 702 can further comprise training the ML model to predict one or more of the following parameters or characteristics associated with a future analytics request, in addition to predicting the timing of the analytics request(s). In particular, the ML model can be trained to predict a subject of the future analytics request, e.g., the type of analytics report that is required for that request. The ML model can be trained to predict an identity of a network node that is going to send the analytics request. The ML model can be trained to predict an identity of one or more other network nodes to which an analytics report generated according to the analytics request is to be sent, i.e., the model can predict which other network nodes might make a similar analytics request and/or which other network nodes might benefit from receiving the same analytics report. The ML model can be trained to predict a type of network node to which an analytics report generated according to the analytics request is to be sent, e.g., SMF, PCF, etc. The ML model can be trained to predict a type of data required to generate an analytics report requested by the analytics request, e.g., network congestion data, etc. The ML model can be trained to predict a minimum time period required to obtain the data that is needed for generating an analytics report according to the analytics request, e.g. so that the network node can allow enough time to prefetch the data before an analytics request is received. The ML model can predict a periodicity for the analytics request, i.e., predict how often the analytics request will be made.

It will be appreciated that to enable the above embodiments, step 701 can comprise obtaining suitable information for training the ML model to make those predictions of the parameter(s) or characteristic(s) of the future analytics request(s). For example, step 701 can comprise obtaining information on any one or more of: a subject of previous analytics requests; an identity of the network nodes that sent the previous analytics requests; an identity of one or more other network nodes to which analytics reports are to be sent in response to the previous analytics requests; a type of network node to which the analytics reports are to be sent in response to the previous analytics requests; a type of data required to generate the analytics reports to be sent in response to the previous analytics requests; a minimum time period required to obtain the data that is needed for generating the analytics reports to be sent in response to the previous analytics requests; and a periodicity for the previous analytics requests.

In some embodiments, the training of the ML model in step 702 or retraining the ML model is in response to a training trigger signal. For example, in response to receiving a training trigger signal, the first network node can initiate the collection of further information on the timing of previous analytics requests by one or more network nodes, and then retrain the ML model using the obtained further information.

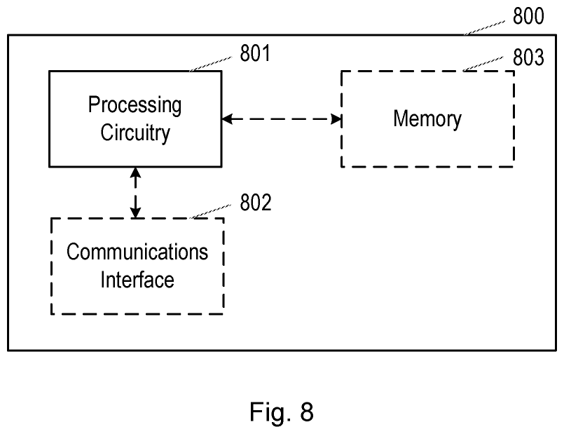

FIG. 8 is a simplified block diagram of a network node 800 according to some embodiments that can be used to implement one or more of the techniques described herein. The network node 800 can be a NF, a network data analytics node or function, such as a NWDAF, or one or more logical functions that form part of a network data analytics node, such as an AnLF, a MTLF, or Prefetching Pattern Model Provider (PPMP).

The network node 800 comprises processing circuitry (or logic) 801. It will be appreciated that the network node 800 may comprise one or more virtual machines running different software and/or processes. The network node 800 may therefore comprise, or be implemented in or as one or more servers, switches and/or storage devices and/or may comprise cloud computing infrastructure that runs the software and/or processes.

The processing circuitry 801 controls the operation of the network node 800 to implement the relevant part of the methods described herein. The processing circuitry 801 can comprise one or more processors, processing units, multi-core processors or modules that are configured or programmed to control the network node 800 in the manner described herein. In particular implementations, the processing circuitry 601 can comprise a plurality of software and/or hardware modules that are each configured to perform, or are for performing, individual or multiple steps of the method described herein in relation to the network node 800.

The network node 800 also comprises a communications interface 802. The communications interface 802 is for use in enabling communications with other network node, computers, servers, etc. For example, the communications interface 802 can be configured to transmit to and/or receive from other network nodes requests, acknowledgements, information, data, signals, or similar. The communications interface 802 can use any suitable communication technology.

The processing circuitry 801 may be configured to control the communications interface 802 to transmit to and/or receive from other network nodes, etc. requests, acknowledgements, information, data, signals, or similar, according to the methods described herein.

The network node 800 may comprise a memory 803. In some embodiments, the memory 803 can be configured to store program code that can be executed by the processing circuitry 801 to perform the method described herein in relation to the network node 800. Alternatively or in addition, the memory 803 can be configured to store any requests, acknowledgements, information, data, signals, or similar that are described herein. The processing circuitry 801 may be configured to control the memory 803 to store such information therein.

Although the network node may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

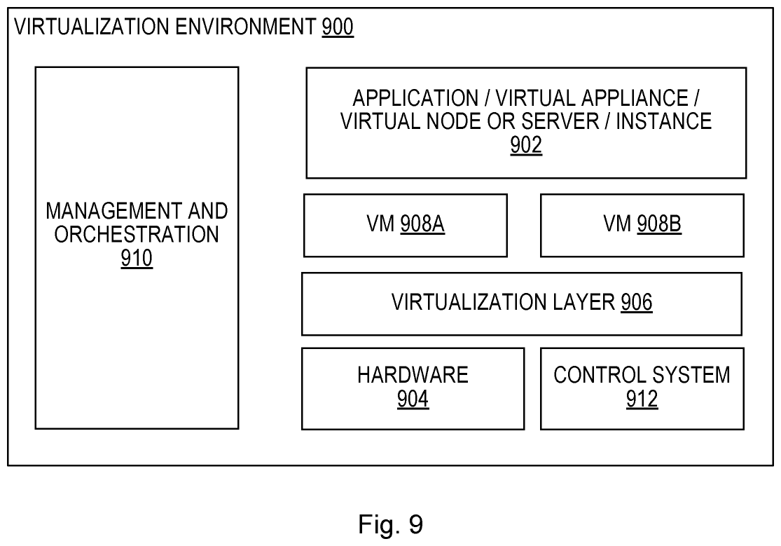

FIG. 9 is a block diagram illustrating a virtualization environment 900 in which functions implemented by some embodiments may be virtualized. The virtualization environment 900 can implement the functions of any of a NF, a network data analytics node or function, such as a NWDAF, or one or more logical functions that form part of a network data analytics node, such as an AnLF, a MTLF, or Prefetching Pattern Model Provider (PPMP).

In the present context, virtualizing means creating virtual versions of network nodes which may include virtualizing hardware platforms, storage devices and networking resources. As used herein, virtualization can be applied to any network node described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 900 hosted by one or more of hardware nodes, such as a hardware computing device that operates as a network node. Further, the network node may be entirely virtualized.

Applications 902 (which may alternatively be called software instances, virtual appliances, network functions, virtual nodes, virtual network functions, etc.) are run in the virtualization environment 900 to implement some of the features, functions, and/or benefits of some of the embodiments disclosed herein.

Hardware 904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 906 (also referred to as hypervisors or virtual machine monitors (VMMs)), provide VMs 908a and 908b (one or more of which may be generally referred to as VMs 908), and/or perform any of the functions, features and/or benefits described in relation with some embodiments described herein. The virtualization layer 906 may present a virtual operating platform that appears like networking hardware to the VMs 908.

The VMs 908 comprise virtual processing, virtual memory, virtual networking or interface and virtual storage, and may be run by a corresponding virtualization layer 906. Different embodiments of the instance of a virtual appliance 902 may be implemented on one or more of VMs 908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 908 may be a software implementation of a physical machine that runs programs as if they were executing on a physical, non-virtualized machine. Each of the VMs 908, and that part of hardware 904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 908 on top of the hardware 904 and corresponds to the application 902.

Hardware 904 may be implemented in a standalone network node with generic or specific components. Hardware 904 may implement some functions via virtualization. Alternatively, hardware 904 may be part of a larger cluster of hardware (e.g. such as in a data center or Customer Premise Equipment (CPE)) where many hardware nodes work together and are managed via management and orchestration 910, which, among others, oversees lifecycle management of applications 902. In some embodiments, hardware 904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signalling can be provided with the use of a control system 912 which may alternatively be used for communication between hardware nodes and radio units.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the scope of the disclosure. Various exemplary embodiments can be used together with one another, as well as interchangeably therewith, as should be understood by those having ordinary skill in the art.

1-19. (canceled)

20. A first network node for use in a communication network, the first network node configured to:
use a Machine Learning, ML model to predict a timing of one or more analytics requests by a second network node to the first network node, wherein an analytics request is a request by the second network node for an analytics report;
before the predicted timing of a first analytics request, obtain data relating to the first analytics request from one or more data sources;
generate a first analytics report relating to the first analytics request by analysing the obtained data; and
send the generated first analytics report to the second network node prior to the predicted timing of the first analytics request.

21. A first network node as claimed in claim 20, wherein the generated first analytics report is sent to the second network node prior to an analytics request for the first analytics report being received from the second network node.

22. A first network node as claimed in claim 20, wherein the ML model is further used to predict one or more of:
a subject of the first analytics request;
an identity of the second network node;
an identity of one or more other network nodes to which the first analytics report is to be sent;
a type of network node to which the first analytics report is to be sent;
a type of data required to generate the first analytics report;
a minimum time period required to obtain the data that is needed for generating the first analytics report; and
a periodicity for the first analytics request.

23. A first network node as claimed in claim 20, wherein the first network node is a Network Data Analytics Function, NWDAF.

24. A first network node as claimed in claim 20, wherein the ML model is used by an Analytics Logical Function, AnLF.

25. A first network node as claimed in claim 20, wherein the first network node is configured to use a report generation model to generate the report.

26. A first network node for use in a communication network, the first network node configured to:
obtain information on a timing of previous analytics requests by one or more other network nodes, wherein the previous analytics requests are requests to the first network node for one or more analytics reports; and
train a Machine Learning, ML model using the obtained information, wherein the ML model is trained to predict a timing of a first analytics request for a first analytics report.

27. A first network node as claimed in claim 26, wherein the ML model is further trained to predict one or more of:
a subject of the first analytics request;
an identity of the network node that will send the first analytics request;
an identity of one or more other network nodes to which the first analytics report is to be sent;
a type of network node to which the first analytics report is to be sent;
a type of data required to generate the first analytics report;
a minimum time period required to obtain the data that is needed for generating the first analytics report; and
a periodicity for the first analytics request.

28. A first network node as claimed in claim 26, wherein the obtained information further comprises information on one or more of:
a subject of the previous analytics requests;
an identity of the network nodes that sent the previous analytics requests;
an identity of one or more other network nodes to which analytics reports are to be sent in response to the previous analytics requests;
a type of network node to which the analytics reports are to be sent in response to the previous analytics requests;
a type of data required to generate the analytics reports to be sent in response to the previous analytics requests;
a minimum time period required to obtain the data that is needed for generating the analytics reports to be sent in response to the previous analytics requests; and
a periodicity for the previous analytics requests.

29. A first network node as claimed in claim 26, wherein the first network node is a Network Data Analytics Function, NWDAF.

30. A first network node as claimed in claim 26, wherein the trained ML model is provided to an Analytics Logical Function, AnLF.

31. A first network node as claimed in claim 26, wherein the ML model is trained by a Model Training Logical Function, MLTF.

32. A first network node as claimed in claim 31, wherein the trained ML model is stored in a machine learning, ML, repository.

33. A first network node as claimed in claim 26, wherein the ML model is trained in an Analytics Logical Function, AnLF.

34. A first network node as claimed in claim 26, wherein the ML model is any of a: time-series forecasting model; an autoregressive moving average, ARMA, forecasting model; an autoregressive integrated moving average, ARIMA, forecasting model; a long short-term memory, LSTM, forecasting model; a recurrent neural network, RNN; an attention-based LSTM forecasting model; a N-BEATS model; a DeepAR model, a Temporal Fusion Transformer, TFT, model; and a Spacetimeformer model.

35. A first network node as claimed in claim 26, wherein the first network node is further configured to:
train the ML model or retraining the ML model in response to a training trigger signal.

36. A first network node as claimed in claim 35, wherein the first network node is further configured to:
in response to a training trigger signal, initiate the collection of further information on the timing of previous analytics requests by one or more network nodes; and
retrain the ML model using the obtained further information.

37. A first network node as claimed in claim 26, wherein the ML model is trained using information on a timing of previous analytics requests by the one or more other network nodes, so that the trained ML model predicts the timing of analytics requests by the one or more other network nodes.

38. A first network node comprising a processor and a memory, said memory containing instructions executable by said processor whereby said first network node is operative to:
use a Machine Learning, ML model to predict a timing of one or more analytics requests by a second network node to the first network node, wherein an analytics request is a request by the second network node for an analytics report;
before the predicted timing of a first analytics request, obtain data relating to the first analytics request from one or more data sources;
generate a first analytics report relating to the first analytics request by analysing the obtained data; and
send the generated first analytics report to the second network node prior to the predicted timing of the first analytics request.

39. A first network node as claimed in claim 38, wherein the generated first analytics report is sent to the second network node prior to an analytics request for the first analytics report being received from the second network node.

40-55. (canceled)
